(19) United States
(12) Patent Application Publication
(10) Pub. No.: US 2005/0150112 A1
(43) Pub. Date: Jul. 14, 2005

(54) Ion hair trimming device

(75) Inventor: Michael Cafaro, El Paso, TX (US)

Correspondence Address: VINSON & ELKINS, L.L.P., 1001 FANNIN STREET, 2300 FIRST CITY TOWER, HOUSTON, TX, 77002-6760, US

(73) Assignee: Helen of Troy Limited

(21) Appl. No.: 10/757,380

(22) Filed: Jan. 14, 2004

(51) Int. Cl. B26B 19/00

(52) U.S. Cl. 30/34.05; 30/43.92

(57) ABSTRACT

A hair clipping device includes a motor, an electrostatic ion generator, a power cord, a switch and an indicating light, all housed within an elongated plastic housing and an opening in the housing for the discharge of the ions positioned so that the ions are directed towards the hair being trimmed.

### SUMMARY

The present invention relates to grooming devices, more specifically hair clipping devices designed for use in trimming hair. The device includes a motor, an electrostatic ion generator, a power cord, a switch and an indicating light, all housed within an elongated plastic housing. The device also utilizes a tapered blade assembly at one end of the device housing. The power cord is connected to the switch and the switch is connected to control the motor, electrostatic ion generator and indicating light. When the switch is engaged it provides power to the motor, electrostatic ion generator and indicating light. The electrostatic ion generator's output is coupled between positive and negative electrode arrays. Preferably, the positive electrode array is a pointed electrode and the negative electrode array includes an annular-like electrode having a central opening coaxial with the associated pointed electrode. Preferably, the annular-like electrodes are formed from a single sheet of metal by extrusion or punching such that the surface of the annular-like electrode is smooth and continuous. The opening for the discharge of the ions is positioned so that the ions are directed towards the hair being trimmed.

Cutting hair requires precise control of hair being trimmed in order to get a clean, crisp hair trim. In order to get a perfect hair trim one is required to thoroughly wet the hair or utilize other styling agents in order to maintain tight control of the hair being trimmed. It is therefore beneficial to have a hair trimming device that would allow a person to achieve a precise hair trim without having to wet or utilize styling agents on the hair thus causing hair to stick on the blades of the trimming device. It is thus an object of the present invention to allow the user to trim hair without having to wet or utilize styling agents on the hair. The present invention utilizes an electrostatic ion generator that discharges negative ions onto the hair in order to have better control of the hair by eliminating static control and frizzys caused by the constant combing during trimming. The negative ions provide two benefits, (i) eliminating static control, thus eliminating flyaway hair and (ii) attaching themselves to the positively charged hair being trimmed and causing the trimmed hair to fall to the floor instead of being attracted to the cutting blades that create positive ions due to their cutting motion.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a top view of a preferred embodiment of a trimming device.

FIG. 2 is a side view of a preferred embodiment of a trimming device.

FIG. 3 is an electrical diagram used in preferred embodiments of a trimming device.

### DETAILED DESCRIPTION

An embodiment of the present invention is shown in top view in FIG. 1. The preferred device 10 is an electric hair trimming device as is often used in hair styling applications. The device includes a housing 12 that may be composed of a plastic or metal material, metal cutting blades 14 and a power cord 16 for connection to a power source. The embodiment shown in FIG. 1 includes the power switch 18 with which the device is turned on or off. An indicator light 20 connected to the power switch provides an indication that the device power is on. The top of the device also includes an opening 22 for ion discharge. In preferred embodiments the blades may be made of stainless steel, titanium, carbon steel or other metallic materials. Also shown are opposing latches 24 that allow a user to remove the blades to add different attachments to the device.

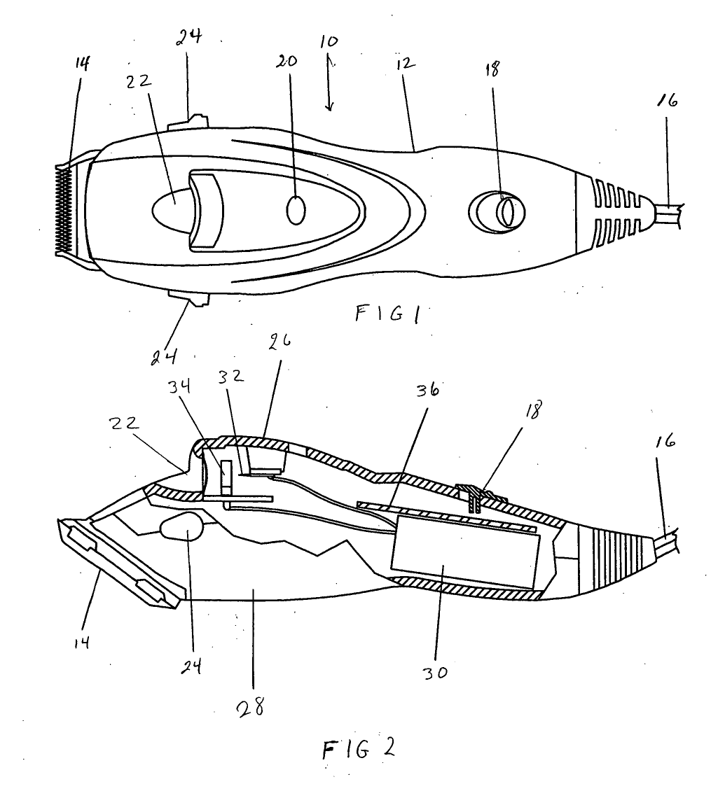

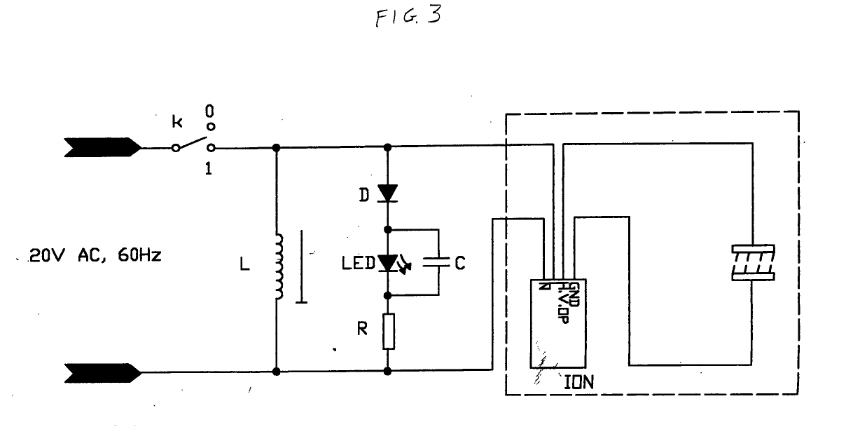

A side view of the preferred device is shown in FIG. 2. In preferred embodiments the housing 12 is composed of two pieces, a top housing 26 and a bottom housing 28. In the view shown in FIG. 2, part of the housing is cut away to show the internal features of the device. Shown within the housing is an electrostatic ion generator 30, which generates a voltage across the positive 32 and negative 34 electrodes, thus creating a flow of ions through the opening 22. Also shown within the housing is a printed circuit board 36 containing the device's electrical circuits.

A schematic view of an electrical circuit of the device is shown in FIG. 3. The circuits shown include the power switch, the electronic display/indicator circuit, motor and the ion generation circuit.

1. An electric hair trimming device comprising:
a set of cutting blades for trimming hair, and
an ion generator configured to direct a flow of ions toward the cutting blades during use.

2. The device of claim 1, wherein the ions are generated between positive and negative electrodes and further wherein the positive electrode is a pointed electrode and the negative electrode is an annular electrode array comprising a central opening coaxial with the associated positive electrode.

3. The device of claim 2, wherein the negative electrodes comprise a smooth continuous surface.

4. The device of claim 3, wherein the negative electrode array is formed from a single sheet of metal by extrusion or punching.

5. An electric hair trimming device comprising:
a housing;
cutting blades configured for trimming hair;
an ion generator comprising positive and negative electrodes contained within the housing; and
an opening in the housing adjacent the electrodes of the ion generator;
wherein the ion generator is configured to direct a stream of negative ions toward the hair being trimmed during use.

6. The device of claim 5, wherein the positive electrode is a pointed electrode and the negative electrode is an annular electrode array comprising a central opening coaxial with the associated positive electrode.

7. The device of claim 6, wherein the negative electrode array is formed from a single sheet of metal by extrusion or punching.

8. An electric hair trimming device comprising:
a housing;
cutting blades attached to the housing and configured for trimming hair; and
an ion generator comprising positive and negative electrodes contained within the housing and configured to direct a stream of negative ions toward the cutting blades during use;
wherein the positive electrode is a pointed electrode and the negative electrode is an annular electrode array comprising a central opening coaxial with the associated positive electrode;
wherein the negative electrode array is formed from a single sheet of metal by extrusion or punching; and
further wherein the housing provides an opening adjacent the electrodes of the ion generator effective to allow the stream of ions generated within the housing to flow toward the hair being trimmed during use.

9. A method of clipping hair comprising:
contacting the hair with an electric hair trimming device, wherein the hair trimming device directs a stream of negative ions onto the hair being clipped.

10. An improved hair clipping device comprising a motor, a power cord, a switch and an indicating light, all housed within an elongated housing, wherein the improvement comprises an electrostatic ion generator contained within the housing and configured to direct negative ions through an opening provided in the housing and onto hair being clipped during use.

11. The improved device of claim 10, wherein the electrostatic ion generator comprises a positive electrode and a negative electrode, and further wherein the positive electrode is a pointed electrode and the negative electrode is an annular electrode array comprising a central opening coaxial with the associated positive electrode.

12. The device of claim 11, wherein the negative electrode is formed from a single sheet of metal by extrusion or punching and comprises a smooth continuous surface.
